(19) United States
(12) Patent Application Publication
(10) Pub. No.: US 2016/0076455 A1
(43) Pub. Date: Mar. 17, 2016

(54) METHOD AND SYSTEM TO PROTECT A SURFACE FROM CORROSIVE POLLUTANTS

(71) Applicant: General Electric Company, Schenectady, NY (US)

(72) Inventors: Sanji Ekanayake, Mableton, GA (US); Dale Joel Davis, Greenville, SC (US); Robert Michael Orenstein, Atlanta, GA (US); Alston Ilford Scipio, Mableton, GA (US); Raub Warfield Smith, Ballston Lake, NY (US)

(21) Appl. No.: 14/484,774

(22) Filed: Sep. 12, 2014

(51) Int. Cl. F02C 7/30; F02C 9/00

(52) U.S. Cl. CPC F02C 7/30; F02C 9/00; F05D 2220/32; F05D 2270/11; F05D 2270/30; F05D 2260/95

(57) ABSTRACT

Disclosed herein are systems and methods for protecting a surface from corrosive pollutants. A method includes detecting airborne corrosive pollutants proximate to a surface using at least one sensor adapted to detect a concentration of the airborne corrosive pollutants and/or one or more types of airborne corrosive pollutants, the concentration of the airborne corrosive pollutants being an instantaneous concentration value or a time-weighted-integrated concentration value; selecting a fluid to deliver to at least a portion of the surface based upon a predetermined type and/or concentration of the airborne corrosive pollutants detected by the at least one sensor; and initiating a fluid treatment to deliver the selected fluid such that the selected fluid contacts the at least a portion of the surface.

### BACKGROUND OF THE INVENTION

A turbomachine such as a gas turbine operates in diverse environments and a variety of climates. A surface of a turbomachine such as a compressor of a gas turbine engine is exposed to dust ingestion and/or entry of a dislodged foreign object, resulting in varying degrees of damage, e.g., corrosion, tip erosion/rubs, trailing edge thinning and stator root erosion. A gas turbine engine also has blades and other components which over time in operation are subjected to the buildup of deposits of various residues resulting from byproducts of the combustion process. Such damage and deposit formation results in loss of turbine efficiency and potential degradation of gas turbine engine components.

Airborne corrosive pollutants such as sulfur dioxide (SO₂) gas, sulfate aerosols, chlorides, sea salt aerosols, and/or other pollutants also come into contact with and corrode components of the gas turbine engine. Component corrosion results in at least partial compressor overhaul and/or component repair and/or replacement. This in turn results in repair and/or replacement costs and production downtime. In addition to repairing and/or replacing corroded surfaces, various treatment methods are utilized to counter damage caused by pollutants.

It is therefore desirable to provide a system and method to detect the particular pollutant conditions to which a specific surface, such as the surface of a gas turbine component, has been subjected and to provide and effectively deliver a targeted treatment fluid to protect and/or mitigate the surface from damage therefrom, thereby extending the lifetime of the component, reducing the frequency of repair and/or replacement and/or improving the productivity of the gas turbine.

### BRIEF DESCRIPTION OF THE INVENTION

According to one aspect of the invention, a method comprises detecting airborne corrosive pollutants proximate to a surface using at least one sensor adapted to detect a concentration of the airborne corrosive pollutants and/or one or more types of airborne corrosive pollutants, the concentration of the airborne corrosive pollutants being an instantaneous concentration value or a time-weighted-integrated concentration value; selecting a fluid to deliver to at least a portion of the surface based upon a predetermined type and/or concentration of the airborne corrosive pollutants detected by the at least one sensor; and initiating a fluid treatment to deliver the selected fluid such that the selected fluid contacts the at least a portion of the surface.

According to another aspect of the invention, a system comprises a surface; a pipe in fluid communication with the surface; a valve fixedly attached to the pipe; a source of a fluid, the source of fluid being in fluid communication with the pipe; at least one sensor adapted to detect a concentration of airborne corrosive pollutants and/or one or more types of airborne corrosive pollutants, the at least one sensor being disposed proximate to the surface, the concentration of the airborne corrosive pollutants being an instantaneous concentration value or a time-weighted-integrated concentration value; and a control system in operative communication with the at least one sensor and the valve, the control system being configured to select the fluid based upon a predetermined type and/or concentration of the airborne corrosive pollutants detected by the at least one sensor and to deliver the selected fluid such that the selected fluid contacts the at least a portion of the surface.

According to another aspect of the invention, a system comprises a processor adapted to execute computer-readable instructions; and a memory communicatively coupled to said processor, said memory having stored therein the computer-readable instructions that, if executed by the processor, cause the processor to perform operations comprising: receiving a set of data associated with airborne corrosive pollutants proximate to a surface; and providing instructions to deliver a selected fluid such that the selected fluid contacts at least a portion of the surface based upon the set of data and a predetermined type and/or concentration of the airborne corrosive pollutants wherein the set of data comprises a concentration of airborne corrosive pollutants and/or one or more types of airborne corrosive pollutants, the concentration of the airborne corrosive pollutants being an instantaneous concentration value or a time-weighted-integrated concentration value.

These and other advantages and features will become more apparent from the following description taken in conjunction with the drawings.

### BRIEF DESCRIPTION OF THE DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is an exemplary illustration of a power plant system;

FIG. 2 is a sectional view of a gas turbine engine including turbine piping and compressor piping;

FIG. 3 illustrates a non-limiting, exemplary method of applying a fluid to a gas turbine engine; and

FIG. 4 is an exemplary block diagram representing a general purpose computer system in which aspects of the methods and systems disclosed herein or portions thereof may be incorporated.

### DETAILED DESCRIPTION OF THE INVENTION

Disclosed herein are methods and systems to protect a surface from corrosive pollutants. At least one sensor or sensor array is utilized to detect a concentration and/or one or more types of airborne corrosive pollutants proximate to a surface, such as a surface of a turbomachine, e.g., a gas turbine engine. A targeted treatment fluid, such as an anticorrosion fluid, which is particularly selected according to the particular pollutant conditions detected proximate to the surface, is employed when the airborne corrosive pollutants detected by the at least one sensor meet or exceed a predetermined type and/or concentration threshold for the airborne corrosive pollutants. The method of delivery of the fluid to the surface is particularly selected to facilitate delivery to the surface in the particular application or environment in which the surface is employed such that the selected fluid contacts at least a portion of the surface.

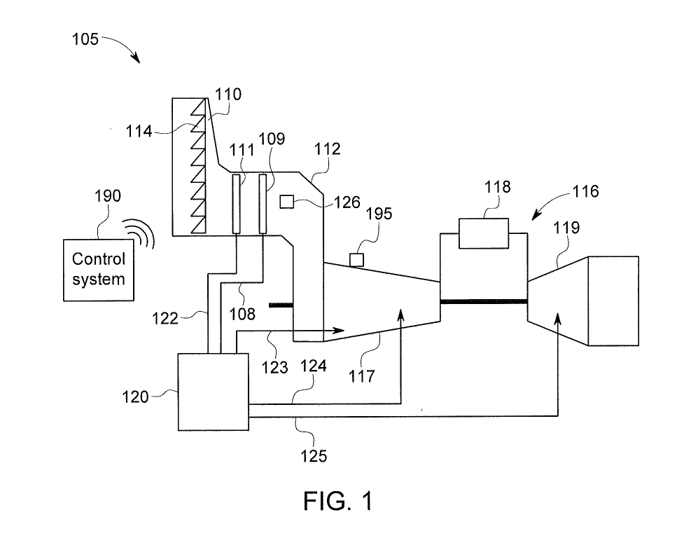

FIG. 1 is an exemplary illustration of a power plant system 105. In normal operation, air flows into the inlet filter house 110 via the inlet hoods 114, and through a plurality of filter elements (not shown). The filtered inlet air passes through a duct 112 (or similar passage) to a gas turbine engine 116. Although embodiments described herein refer to a gas turbine engine as an exemplary surface, the system and methods described herein may be used to provide (or apply) a treatment fluid to any desired surface, including but not limited to turbomachines such as gas turbine engines. Duct 112 may contain an evaporative cooling system 111 and an inlet bleed heat (IBH) system 109. Gas turbine engine 116 includes a compressor 117, a combustion section 118, and a turbine 119. High pressure air from compressor 117 enters the combustion section 118 of gas turbine engine 116 where the air is mixed with fuel and burned.

In an embodiment, an inlet fogger system may be similarly situated at or near evaporative cooling system 111 in power plant system 105. Evaporative cooling system 111 is used synonymously with an inlet fogger system, as discussed herein. The function of the evaporative cooling system 111 is to increase power output from the engine by cooling the inlet air to the machine by vaporizing water.

With regard to the IBH system 109, IBH is used to protect the gas turbine engine compressor 117 from icing. IBH may also be used to reduce the compressor pressure ratio at certain operating conditions where additional compressor operating margin is required. This method of gas turbine engine operation, known as IBH control, raises the inlet temperature of the compressor inlet air by mixing the colder ambient air with the bleed portion of the hot compressor discharge air, thereby reducing the air density and the mass flow to gas turbine engine 116. IBH system 109 is located downstream of the inlet air filters.

Duct 112 includes sensor 126, which detects airborne corrosive pollutants (e.g., airborne corrosive particles) in the air stream passing past sensor 126. Sensor 126 gathers a set of data associated with the airborne corrosive particles in an air stream within duct 112 near a compressor 117 of gas turbine engine 116. Data gathered by sensor 126 includes the type of one or more kinds of airborne corrosive particles and/or the concentration of the airborne corrosive particles (e.g., the total concentration of all the airborne corrosive particles detected and/or of one or more specific types of airborne corrosive particles, among other data that is optionally gathered by the sensor. The data gathered by sensor 126 is used by control system 190 to control delivery of a selected treatment fluid from fluid source 120. The airborne particles which are actively detected by sensor 126 include corrosive particles that contribute to corrosion of internal components of compressor 117.

Examples of corrosive particles include silicon dioxide, sulfates, chlorides, sea salts, and the like or a combination comprising at least one of the foregoing. Sensor 126 is communicatively connected with control system 190. The sensor 126 is a single sensor or a plurality of sensors (i.e., an array) disposed proximate to the desired surface. In an embodiment, there may be an array of sensors near power plant system 105 that are located within duct 112 and outside of duct 112. The sensors detect and report the type and/or concentration of airborne corrosive particles. In another embodiment, data from a sensor array is processed (e.g., determining the average, median, or the like) before or after arriving to control system 190. In yet another embodiment, one or more additional sensors, such as laser and/or light-probe based sensors are disposed proximate to compressor 117, to detect changes in the surface finish of at least one compressor component and is communicatively connected with control system 190 to control delivery of the treatment fluid from fluid source 120.

As illustrated in FIG. 1, evaporative cooling system 111, IBH system 109, compressor 117, and turbine 119 are fluidly connected with fluid source 120. Piping 122 fluidly connects evaporative cooling system 111 with fluid source 120. Piping 108 fluidly connects IBH system 109 with fluid source 120. Piping 123 fluidly connects compressor 117 (e.g., via bellmouth nozzles (not shown)) with fluid source 120. Piping 124 fluidly connects compressor 117 (e.g., via an air extraction system) with fluid source 120. Piping 125 fluidly connects turbine 119 (e.g., via an air extraction system) with fluid source 120. Fluid source 120 includes an anticorrosion fluid or other fluid for washing components of the power plant system 105.

In an embodiment, the fluid is an anticorrosion fluid comprising a polyamine, an acid, a base, an alcohol, or a hydroxide. In another embodiment, the base and/or hydroxide is a “mild” base and/or hydroxide having a pH of from 8 to 12 and/or the acid is a “mild” acid having a pH of from 3 to 6. In yet another embodiment, each of the aforementioned devices and systems is fluidly connected with separate fluid sources. The fluid is delivered to the desired surface while the turbomachine, e.g., the gas turbine engine, is online or offline.

In an embodiment, a polyamine-based fluid is employed as the anticorrosion fluid. As used herein, the term “polyamine” is used to refer to an organic compound having two or more primary amino groups —NH2. In an embodiment, the anticorrosion fluid comprises an anticorrosion agent comprising a volatile neutralizing amine which neutralizes acidic contaminants and elevates the pH into an alkaline range, and with which protective metal oxide coatings are particularly stable and adherent. Non-limiting examples of anticorrosion agents include cycloheaxylamine, morpholine, monoethanolamine, N-9-Octadecenyl-1,3-propanediamine, 9-octadecen-1-amine, (Z)-1-5, dimethylaminepropylamine (DMPA), diethylaminoethanol (DEAE), and the like, or a combination comprising at least one of the foregoing. In another embodiment, the anticorrosion fluid comprises a combination of a polyamine (a multifunction organic amine corrosion inhibitor) and one or more neutralizing amines (volatile organic amines).

In an embodiment, existing compressor bellmouth injection nozzles and modified compressor air extraction and turbine nozzle cooling air piping ports are used to deliver the fluid to at least a portion of the surface, e.g., a gas turbine engine component. The fluid is delivered via any method which facilitates effective delivery of the fluid to the desired surface delivery (e.g., dispersion). In an embodiment, the fluid is delivered to the compressor section and/or the turbine section of the gas turbine engine 116. In another embodiment, the fluid is delivered to both the compressor section and turbine section either simultaneously or sequentially. In an aspect of the embodiment, the selected fluid delivered to the compressor section and turbine section may be the same or, may be tailored to have a different compositions and/or blend ratio according to the different material composition and coatings in the turbine and compressor sections and are delivered to the compressor section and turbine section, respectively, by varying the valve alignment therein.

In an embodiment, the anticorrosion fluid includes a mixture of a polyamine-based fluid and water and stored in fluid source 120. The water-polyamine mixture is of a predetermined ratio and inserted into evaporative cooling system 111 via piping 122 or IBH system 109 via piping 108. The water-polyamine mixture is transformed to a vapor (e.g., steam) or aerosolized (e.g., fog) via the evaporative cooling system 111 or IBH system 109. The polyamine based vapor travels through duct 112 and into the compressor bellmouth 75. There are an assortment of valves, mixing chambers, sensors, controls, or the like, as discussed and implied herein, that determine whether to use the anticorrosion fluid and assist in the application of the anticorrosion fluid to the desired surface. The evaporative cooling system 111, IBH system 109, or other systems to facilitate the delivery of the anticorrosion fluid are employed when gas turbine engine 116 is online. Whether gas turbine engine 116 is online is determined based on power output level, and/or the temperature of components of gas turbine engine 116.

The treatment fluid is supplied from a source which is integrated within the power plant system or is external to the system. In an embodiment, a source of fluid is supplied from an independent and external source, such as a tanker truck. The external source is manually connected via quick disconnect provisions on piping 122, piping 108, piping 123, piping 124, or piping 125.

In an embodiment, water and one or more anticorrosion agents are mixed in a predetermined ratio to form an anticorrosion fluid. The water-anticorrosion agent mixture is stored in a separate storage tank (e.g., a premixed anticorrosion fluid). The mixture of the resulting anticorrosion fluid is based, among other factors, on the gas turbine engine frame size, duration of wash in combination with discharge, or flow requirement. The ratio is adjusted based on the type of amine.

In an embodiment, the anticorrosion fluid is dispersed to create a molecular layer coating (a micro-coating on metal). Metal passivation imparts a protective shield to metal and/or metal alloy substrates from environmental factors (e.g., high temperatures, combustion by-products, debris, etc.) exhibited in gas turbine engines by forming a coating (e.g., a metal oxide layer) which protects the metal or metal alloy substrate from corrosive species. In an aspect of the embodiment, the coating that results from the application of the anticorrosion fluid serves to strengthen the bonds in the metal or metal alloy substrate of a surface, such as compressor 117. Based on the mixture of the anticorrosion fluid (e.g., type of anticorrosion agents), significant thermal decomposition of the anticorrosion coating may not be exhibited until temperatures above 500° C. is reached. In another embodiment, successive anticorrosion treatment cycles are applied to the compressor 117 using the systems described herein, resulting in a multi-layer anticorrosion coating.

The anticorrosion fluid imparts corrosion resistance and/or inhibition to a desired surface such as compressor 117 by using metal passivation to provide an anticorrosion coating on the metal and/or metal alloy substrates in a gas turbine engine with which the anticorrosion mixture comes into contact via entry points, as discussed herein. The resultant anticorrosion fluid (partially or fully) coats stages of compressor 117 of the gas turbine engine 116 and various metallic components therein (e.g., compressor blades and stator vanes).

Referring to FIG. 1, valving (not shown) enables selection between different sources and/or concentrations of anticorrosion agents or fluids based on the pollutant data detected by the sensor and the particular application (or climate) of the desired surface and/or delivery of the fluid to the desired surface, e.g., compressor 117. In an embodiment, the anticorrosion fluid is or comprises steam. The anticorrosion fluid is supplied from an external source, e.g., a truck, and is manually connected via the quick disconnects as disclosed herein. In an aspect of the embodiment, the anticorrosion fluid is mixed automatically at a predetermined ratio (e.g., adjustable based on the type of amine) and delivered or dispersed thereafter. Inlet and drain valves are optimally positioned and aligned to facilitate delivery of the anticorrosion fluid to the desired surface.

In an embodiment, power plant system 105 further comprises one or more additional sensors (not shown) such as a motor sensor, a fluid level sensor, a fluid pressure sensor, a mixture outflow pressure sensor, a compressor pressure sensor which senses pressure in a compressor section of a gas turbine engine, a turbine pressure sensor which senses pressure in gas turbine engine 116, and/or valve position sensors, among other sensors. In an aspect of the embodiment, power plant system 105 further comprises one or more flow sensors configured to sense the rate of flow of a fluid flowing (or not flowing) through piping.

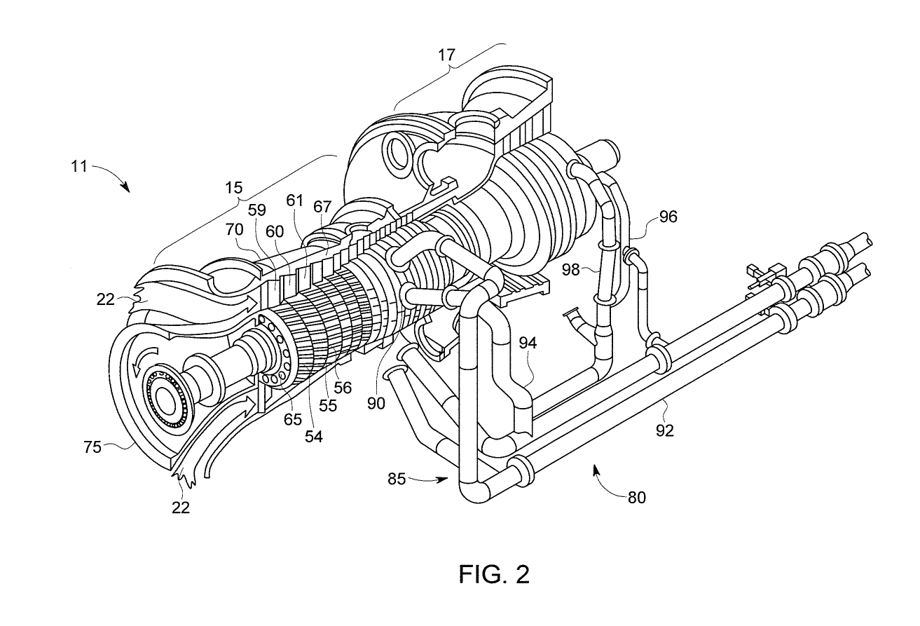

FIG. 2 is an exemplary illustration of a gas turbine engine 11 that includes cooling and sealing air valve and pipe components. Compressor 15 includes one or more stages. As shown in FIG. 2, there may be an A-stage 54, a B-stage 55, or C-stage 56 of the compressor. The terms “A-stage”, “X-stage”, and the like are used herein as opposed to “first stage”, “second stage,” and the like so as to prevent an inference that the systems and methods described herein are in any way limited to use with the actual first stage or the second stage of the compressor or the turbine. Any number of the stages may be used. Each stage includes a number of circumferentially arranged rotating blades, such as blade 59, blade 60, and blade 61. Any number of blades may be used. The blades are mounted onto a rotor wheel 65. The rotor wheel 65 is attached to the power output drive shaft for rotation therewith. Each stage optionally further includes a number of circumferentially arranged stationary vanes (vanes 67). Any number of the vanes 67 may be used. The vanes 67 may be mounted within an outer casing 70. The outer casing 70 extends from a bellmouth 75 towards turbine 17. The flow of air 22 enters the compressor 15 about the bellmouth 75 and is compressed through the blades (e.g., blade 59, blade 60, and blade 61, among others) and the vanes 67 of the stages before flowing to the combustor.

The gas turbine engine 11 further comprises an air extraction system 80. The air extraction system 80 extracts a portion of the flow of air 22 in the compressor 15 for use in cooling the turbine and for other purposes. The air extraction system 80 includes one or more air extraction pipes 85. The air extraction pipes 85 extend from an extraction port 90 about one of the compressor stages towards one of the stages of turbine 17. The one or more air extraction pipes 85 are any number and/or type of pipes and are in any position and/or configuration which is suitable for air extraction. As used herein, the terms “X-stage extraction pipe” and “Y-stage extraction pipe” generally refer to one or more of any of such suitable extraction pipes. FIG. 2 shows an X-stage extraction pipe 92 and a Y-stage extraction pipe 94. The X-stage extraction pipe 92 is positioned about a ninth stage of compressor 15 and the Y-stage extraction pipe 94 s positioned about the thirteenth stage of compressor 15.

Extractions from other stages of compressor 15 may also be used. The X-stage extraction pipe 92 is in communication with an X-stage pipe 96 of the turbine while the Y-stage extraction pipe 94 is in communication with a Y-stage pipe 98 of turbine 17. The X-stage pipe 96 corresponds to a third stage of turbine 17 and the Y-stage pipe 98 corresponds to a second stage of turbine 17, for example. In an embodiment, the air extraction system 80 is configured to deliver, e.g., disperse, fluid. The use of the aforementioned access points (e.g., access to stages in the turbine 17 or compressor 15) as well as bellmouth nozzles (not shown) and vaporizing systems as discussed herein (e.g., evaporative cooling system or inlet bleed heat system) allow for several ways to selectively deliver fluid to a surface such as a surface of a gas turbine engine.

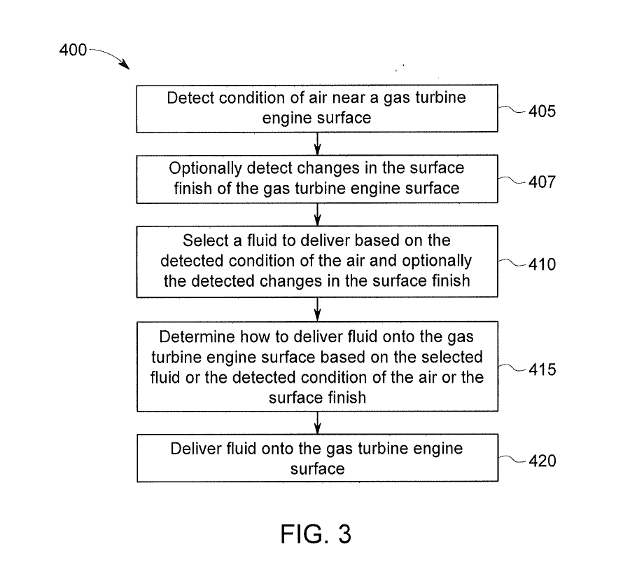

FIG. 3 illustrates a non-limiting, exemplary method 400 of delivering, e.g., dispersing, a fluid to a gas turbine engine. In an embodiment, at step 405, a pollutant condition of air may be determined by a sensor near a gas turbine engine. The condition may include a type of airborne corrosive particles in the air and the concentration of the airborne corrosive particles in the air. In another embodiment at step 407, changes in the surface finish of at least one surface, e.g., a compressor component in the gas turbine engine, are also determined by a sensor proximate to the desired surface.

At step 410, a type of fluid to deliver to the gas turbine engine is selected based on the condition of the air (e.g., the concentration of a type of airborne particle meeting a predetermined threshold level) near the gas turbine engine. The fluid may also be selected based on additional conditions. For example, the conditions may include conditions of the gas turbine engine, such as the type of gas turbine engine, the amount of damage to the gas turbine engine, the temperature of the gas turbine engine at different components (e.g., compressor section or turbine section), whether the gas turbine engine is clean, how long the gas turbine engine has been in operation, elapsed time since a washing of the compressor 117, a duration of the washing of the compressor 117, or a fluid and additive blend used for the washing of the compressor 117, the power output level of the gas turbine engine, or the like.

At step 415, the manner in which the selected fluid is delivered to the gas turbine engine is based on the condition of the gas turbine engine, the condition of the air, and/or the fluid selected. For example, although an anticorrosion fluid, such as a polyamine-based fluid, is substantially heat resistant, some anticorrosion fluids ay become ineffective at certain temperatures. A suitable delivery method is selected according to the particular stage of the gas turbine engine component (e.g., compressor 117 or turbine 119) for which treatment is desired or based on the temperature of the desired surface therein. The location of the application of the anticorrosion fluid is controlled by valves (not shown) in communication with a control system (e.g., control system 190), as discussed herein. The valves are controlled automatically or manually based on one or more threshold conditions (e.g., meeting a threshold temperature). At step 420, the selected fluid is effectively delivered to the desired surface.

Referring back to FIG. 1, in an exemplary embodiment, control system 190 communicates, via wireless or hardwired, with the sensors described herein, and further communicates with actuation mechanisms (not shown) provided to start, stop, or control the speed of motors. The control system opens, closes, or regulates the position of valves used to accomplish the operations of power plant system 105, as described herein.

Control system 190 includes a computer system that is communicatively connected with a panel/display. Control system 190 executes programs to control the operation of power plant system 105 using sensor inputs, and instructions from human operators via human machine interface (HMI) terminals. Control system 190 directs the recordation of airborne corrosive particle concentrations from sensor 126 or other sensors as time-weighted-integrated values of the airborne corrosive particles or instantaneous values. Air samples collected over a selected period of time, e.g., several minutes, are used to determine the time-weighted average concentration, and are referred to as “integrated”. In another embodiment, control system 190 also directs the recordation of changes in the surface finish of at least one surface, e.g., a compressor component, from sensor 195 or other sensors.

The sensor values are recorded to a local or remote database. In addition, in an exemplary embodiment, control system 190 is programmed to alter (or restrict) the ratio of water to polyamine or other anticorrosion agent, alter (or restrict) the cycle times for wash sequences, or alter (or restrict) the order of steps in wash or rinse cycles, or alter the order or restrict the duration of the anticorrosion fluid dispensation.

Control system 190 is communicatively connected with power plant system 105 systems and devices. Once all the predetermined logic permissive for the application of a fluid has been met, a delivery of the fluid while the gas turbine engine 116 is online or offline is initiated and the fluid is effectively delivered to the desired surface. Control system 190 automatically runs the gas turbine engine 116 based on a predetermined/predesigned sequence specifically designed for anticorrosion fluid operating mode. The method for online delivery initiation and operation includes determining that the power output and other turbine control parameters have been satisfied for online or offline delivery. Control system 190 may attempt to maintain a substantially constant air flow from the compressor 117 to facilitate controlling a fuel to compressor discharge pressure ratio such that a combustor state does not lag changes in airflow during the fluid dispersal. During operation this system may have the effect of increasing the “mass flow” through the turbine thereby permitting an increase in power delivered to the grid. With the aforementioned in mind, control system 190 may be configured with the appropriate checks and limitations to ensure that it cannot be used excessively (e.g., abused) for power augmentation, NOx abatement, or grid frequency support.

In an embodiment, during the application of the fluid (e.g., via inlet fogging system, evaporative cooling system, IBH system, bellmouth nozzles, or other systems.), control system 190 may be configured to provide instructions to systems that help control gas turbine engine 116 to maintain an appropriate power output level. An appropriate power level may be manually set, determined by analysis of the current or similar gas turbine engines, or the like. In an embodiment, excessive use may be minimized by restrictive access to change online anticorrosion fluid dispersion control logic. For example, minimal access to change the polyamine water ratio for online anticorrosion fluid dispersion, minimal access to change cycle time for anticorrosion fluid dispersion sequences (e.g., between dispersals), minimal access to change cycle time for online anticorrosion fluid dispersion (e.g., during a dispersal), or the like. Abuse of the online anticorrosion fluid dispersion or other application of the anticorrosion fluid may be indicated by patterns in the frequency and other data, as suggested herein, with regard to the application of the anticorrosion fluid.

Without in any way limiting the scope, interpretation, or application of the claims appearing herein, a technical effect of the embodiments described herein is to provide a system and method for detecting the particular pollutant conditions to which a specific surface, such as the surface of a gas turbine component, has been subjected and to provide and effectively deliver a targeted treatment fluid to protect and/or mitigate the surface from damage therefrom, thereby extending the lifetime of the component, reducing the frequency of repair and/or replacement and/or improving the productivity of the gas turbine. More specifically, a technical effect disclosed herein is the utilization of a selected treatment fluid (i.e., corrosion inhibitors in a ratio of acid and alkaline chemicals) and the effective delivery of the treatment fluid to a desired surface in temperature supportive environmental conditions to promote the formation of a passivation layer on the surface of the desired surface, e.g., gas turbine engine compressor blades and stator vanes. The fluid is selected based on an actively monitored condition of airborne corrosive pollutants near a gas turbine engine surface. Corrosion mitigation helps to maintain recovered performance for a longer duration. The proactive sensing and/or forecasting the potential levels of corrosive particles in the air and automatic application of the treatment fluid reduces the propensity for compressor blade or turbine blade erosion from numerous water washes. Integrating the fluid distribution system into the inlet fogging system, evaporative cooler, air extraction system, and other existing systems, as discussed herein, minimizes a need for new extensive piping runs or casing penetrations.

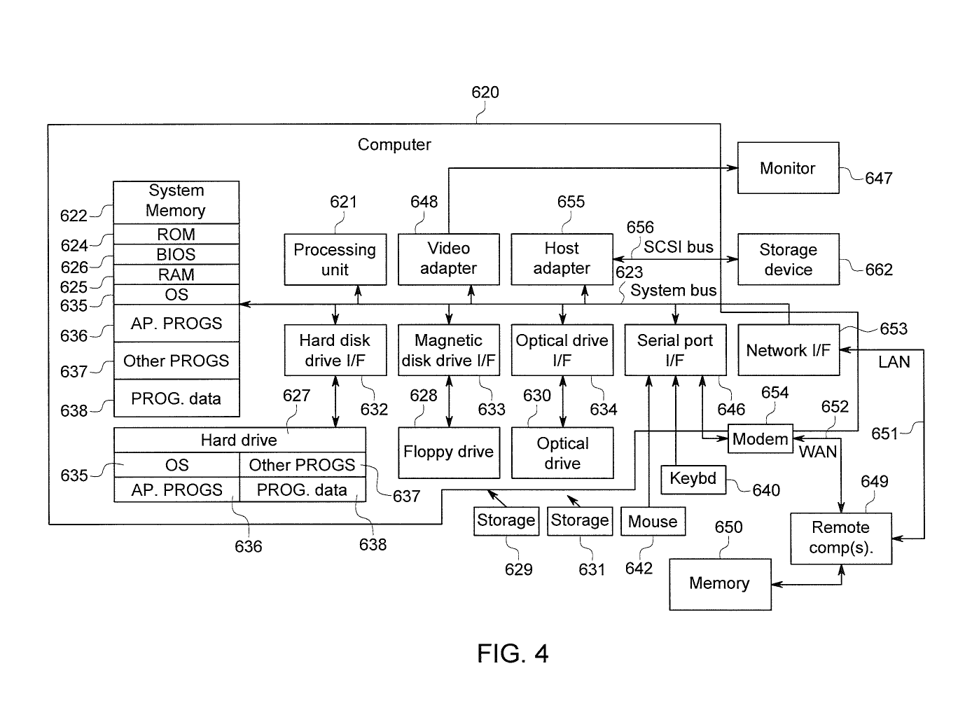

FIG. 4 and the following discussion are intended to provide a brief general description of a suitable computing environment in which the methods and systems disclosed herein and/or portions thereof may be implemented. Although not required, portions of the methods and systems disclosed herein is described in the general context of computer-executable instructions, such as program modules, being executed by a computer, such as a client workstation, server, personal computer, or mobile computing device such as a smartphone. Generally, program modules include routines, programs, objects, components, data structures and the like that perform particular tasks or implement particular abstract data types. Moreover, it should be appreciated the methods and systems disclosed herein and/or portions thereof may be practiced with other computer system configurations, including hand-held devices, multi-processor systems, microprocessor-based or programmable consumer electronics, network PCs, minicomputers, mainframe computers and the like. A processor may be implemented on a single-chip, multiple chips or multiple electrical components with different architectures. The methods and systems disclosed herein may also be practiced in distributed computing environments where tasks are performed by remote processing devices that are linked through a communications network. In a distributed computing environment, program modules may be located in both local and remote memory storage devices.

FIG. 4 is a block diagram representing a general purpose computer system in which aspects of the methods and systems disclosed herein and/or portions thereof may be incorporated. As shown, the exemplary general purpose computing system includes a computer 620 or the like, including a processing unit 621, a system memory 622, and a system bus 623 that couples various system components including the system memory to the processing unit 621. The system bus 623 may be any of several types of bus structures including a memory bus or memory controller, a peripheral bus, and a local bus using any of a variety of bus architectures. The system memory includes read-only memory (ROM) 624 and random access memory (RAM) 625. A basic input/output system 626 (BIOS), containing the basic routines that help to transfer information between elements within the computer 620, such as during start-up, is stored in ROM 524.

The computer 620 may further include a hard disk drive 627 for reading from and writing to a hard disk (not shown), a magnetic disk drive 628 for reading from or writing to a removable magnetic disk 629, and an optical disk drive 630 for reading from or writing to a removable optical disk 631 such as a CD-ROM or other optical or other volatile or non-volatile, removable or non-removable, computer readable media capable of storing data. The hard disk drive 627, magnetic disk drive 628, and optical disk drive 630 are connected to the system bus 623 by a hard disk drive interface 632, a magnetic disk drive interface 633, and an optical drive interface 634, respectively. The drives and their associated computer-readable media provide storage of computer readable instructions, data structures, program modules and other data for the computer 620. As described herein, computer-readable media is a tangible, physical, and concrete article of manufacture and thus not a signal per se. As shown in FIG. 4, the computer 620 optionally further comprises one or more of an operating system 635, application programs 636, other program modules 637, program data 638, a keyboard 640, a mouse 642, serial port 646, a monitor 647, a video adapter 648, one or more remote computers 649, memory 650, a network 653, a modem 654, a host adapter 655, a SCSI Bus 656 and a storage device 662.

In describing embodiments of the subject matter of the present disclosure, as illustrated in the Figures, specific terminology is employed for the sake of clarity. The claimed subject matter, however, is not intended to be limited to the specific terminology so selected, and it is to be understood that each specific element includes all technical equivalents that operate in a similar manner to accomplish a similar purpose. A fluid in the form of a vapor, aerosol, or non-aerosolized liquid may be implemented via the systems disclosed herein. A fluid as discussed herein is considered a substance that has no fixed shape and yields to external pressure, such as a gas, a liquid, an aerosol, or the like. Although a gas turbine engine for a power plant system is discussed, other similar turbine engine configurations are contemplated herein. The anticorrosion fluid discussed herein may be applied simultaneously or separately via different systems, such as an inlet bleed heat system, an evaporative cooling system, a fogger, a bellmouth nozzle, extraction piping, or other piping and devices. Any combination of the features or elements disclosed herein with regard to a fluid may be used in one or more embodiments.

Where the definition of terms departs from the commonly used meaning of the term, applicant intends to utilize the definitions provided herein, unless specifically indicated. The singular forms “a,” “an,” and “the” are intended to include the plural forms as well, unless the context clearly indicates otherwise. It will be understood that, although the terms first, second, etc. may be used to describe various elements, these elements should not be limited by these terms. These terms are only used to distinguish one element from another. The term “and/or” includes any, and all, combinations of one or more of the associated listed items. The phrases “coupled to” and “coupled with” contemplates direct or indirect coupling.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed:

1. A method comprising:
detecting airborne corrosive pollutants proximate to a surface using at least one sensor adapted to detect a concentration of the airborne corrosive pollutants and/or one or more types of airborne corrosive pollutants, the concentration of the airborne corrosive pollutants being an instantaneous concentration value or a time-weighted-integrated concentration value;
selecting a fluid to deliver to at least a portion of the surface based upon a predetermined type and/or concentration of the airborne corrosive pollutants detected by the at least one sensor; and
initiating a fluid treatment to deliver the selected fluid such that the selected fluid contacts the at least a portion of the surface.

2. The method of claim 1, wherein the surface is a turbomachine surface.

3. The method of claim 1, wherein the surface is a gas turbine engine surface or a gas turbine engine compressor surface.

4. The method of claim 1, wherein the airborne corrosive pollutants are within a duct that is fluidly connected with a compressor of a gas turbine engine.

5. The method of claim 1, wherein the airborne corrosive pollutants proximate the surface comprise sulfur dioxide, sulfate, chloride, sea salt or a combination comprising at least one of the foregoing.

6. The method of claim 1, wherein the initiating the fluid treatment to deliver the selected fluid such that the selected fluid contacts the at least a portion of the surface is further based upon at least one of a predetermined elapsed time since a washing of the surface, a predetermined duration of the washing of the surface, or a predetermined fluid used to wash the surface.

7. The method of claim 1, wherein selecting the fluid to deliver the selected fluid such that the selected fluid contacts the at least a portion of the surface is further based upon at least one of a predetermined elapsed time since a washing of the surface, a predetermined duration of the washing of the surface, or a predetermined fluid used to wash the surface.

8. The method of claim 1, wherein the initiating the fluid treatment to deliver the selected fluid such that the selected fluid contacts the at least a portion of the surface comprises dispersing the fluid for a predetermined period of time, the predetermined period of time based on at least one of elapsed time since a washing of the surface, a duration of the washing of the surface, or a fluid and additive blend used for the washing of the surface.

9. The method of claim 1, wherein the surface is a surface of a gas turbine engine and the gas turbine engine is online.

10. The method of claim 1, wherein the surface is a surface of a gas turbine engine and the gas turbine engine is offline.

11. The method of claim 1, wherein the fluid is an anticorrosion fluid.

12. The method of claim 1, wherein the fluid comprises at least one of a polyamine, an acid, a base, alcohol, a hydroxide or a combination comprising at least one of the foregoing.

13. A system comprising:
a surface;
a pipe in fluid communication with the surface;
a valve fixedly attached to the pipe;
a source of a fluid, the source of fluid being in fluid communication with the pipe;
at least one sensor adapted to detect a concentration of airborne corrosive pollutants and/or one or more types of airborne corrosive pollutants, the at least one sensor being disposed proximate to the surface, the concentration of the airborne corrosive pollutants being an instantaneous concentration value or a time-weighted-integrated concentration value; and
a control system in operative communication with the at least one sensor and the valve, the control system being configured to select the fluid based upon a predetermined type and/or concentration of the airborne corrosive pollutants detected by the at least one sensor and to deliver the selected fluid such that the selected fluid contacts at least a portion of the surface.

14. The system of claim 13, wherein the surface is a surface of a gas turbine engine compressor and the at least one sensor is located in a duct that is fluidly connected with the gas turbine engine compressor.

15. The system of claim 13, further comprising compressor section air extraction piping, wherein the pipe is in fluid communication with the compressor section air extraction piping.

16. The system of claim 13, further comprising:
a bellmouth injection nozzle in fluid communication with the pipe.

17. The system of claim 13, wherein the airborne corrosive pollutants comprise corrosive particles that contribute to corrosion of internal components of a turbomachine.

18. The system of claim 13, further comprising:
at least one sensor, communicatively connected with the control system, that detects changes in a surface finish of the surface in order to determine a preselected effective delivery of the fluid onto at least a portion of the surface.

19. A system comprising:
a processor adapted to execute computer-readable instructions; and
a memory communicatively coupled to said processor, said memory having stored therein the computer-readable instructions that, if executed by the processor, cause the processor to perform operations comprising:
receiving a set of data associated with airborne corrosive pollutants proximate to a surface; and
providing instructions to deliver a selected fluid such that the selected fluid contacts at least a portion of the surface based upon the set of data and a predetermined type and/or concentration of the airborne corrosive pollutants
wherein the set of data comprises a concentration of airborne corrosive pollutants and/or one or more types of airborne corrosive pollutants, the concentration of the airborne corrosive pollutants being an instantaneous concentration value or a time-weighted-integrated concentration value.

20. The system of claim 19, wherein the computer-readable instructions executed by the processor cause the processor to effectuate operations further comprising:
determining whether to deliver the selected fluid in an aerosolized form based on the set of data.
